(19) United States
(12) Patent Application Publication
(10) Pub. No.: US 2021/0139773 A1
(43) Pub. Date: May 13, 2021

(54) LARGE AREA SCINTILLATOR PANELS WITH DOPING

(71) Applicant: RAYTHEON COMPANY, Waltham, MA (US)

(72) Inventors: Stephanie Silberstein Bell, North Andover, MA (US); Thomas M. Hartnett, Nashua, NH (US); Richard Gentilman, Acton, MA (US)

(21) Appl. No.: 16/680,594

(22) Filed: Nov. 12, 2019

(51) Int. Cl. C09K 11/77; C04B 35/44; C04B 35/64; C04B 35/626; C04B 41/00; C04B 41/50; C04B 41/87; G01T 1/202

(52) U.S. Cl. CPC C09K 11/7774; C04B 35/44; C04B 35/64; C04B 35/62655; C04B 41/009; C04B 41/0072; C04B 2235/6583; C04B 41/87; G01T 1/2023; C04B 2235/3222; C04B 2235/606; C04B 2235/663; C04B 41/5025

(57) ABSTRACT

A method of making a scintillator material includes forming a dried ceramic composition into a ceramic body with a garnet crystal formula (Gd_{3-x-z}Yₓ)Ce_{z}(Ga_{5-y}Al_{y})O₁₂, where x is about 0 to about 2, y is about 0 to about 5, and z is about 0.001 to about 1.0. The ceramic body is sintered to form a sintered ceramic body. The sintered ceramic body is surrounded by a powder mixture that includes a garnet powder. The density of the sintered ceramic body is increased by applying an increased temperature and isostatic pressure to form the scintillator material.

### GOVERNMENT LICENSE RIGHTS

This invention was made with Government support under HDTRA1-12-C-0040 awarded by the Department of Defense. The Government has certain rights in the invention.

### BACKGROUND

The present disclosure relates to radiation detection, and more specifically, to large area scintillator panels with doping.

A scintillator material emits light, or luminesces, when excited by ionizing radiation. When an incoming particle strikes such a material, the material absorbs the energy of the particle and scintillates, or re-emits, the absorbed energy as light.

A scintillation detector or scintillation counter includes a scintillator material coupled to an electronic light sensor, such as a photomultiplier tube (PMT), photodiode, or silicon photomultiplier. PMTs absorb the light emitted by the scintillator and re-emit the light in the form of electrons via the photoelectric effect. The subsequent multiplication of the electrons results in an electrical pulse that can be analyzed and yield meaningful information about the particle that originally struck the scintillator.

Scintillators are used in a variety of applications, such as radiation detectors, particle detectors, new energy resource exploration, X-ray security, nuclear cameras, computed tomography, and gas exploration. Other applications of scintillators include computerized tomography (CT) scanners and gamma cameras in medical diagnostics.

### SUMMARY

According to one or more embodiments of the present invention, a method of making a scintillator material includes forming a dried ceramic composition into a ceramic body with a garnet crystal formula (Gd_{3-x-z}Yₓ)Ce_{z}(Ga_{5-y}Al_{y})O₁₂, where x is about 0 to about 2, y is about 0 to about 5, and z is about 0.001 to about 1.0. The ceramic body is sintered to form a sintered ceramic body. The sintered ceramic body is surrounded by a powder mixture that includes an oxide powder having a similar composition as the composition to that of the sintered ceramic body. The density of the sintered ceramic body is increased by applying an increased temperature and isostatic pressure to form the scintillator material.

According to some embodiments of the present invention, a method of making a scintillator material includes forming a slurry with a liquid and an oxide powder having the garnet crystal formula (Gd_{3-x-z}Yₓ)Ce_{z}(Ga_{5-y}Al_{y})O₁₂, where x is about x is about 0 to about 2, y is about 0 to about 5, and z is about 0.001 to about 1.0. The slurry is dried to form a dried ceramic powder composition. The dried ceramic powder composition is compacted and formed into a ceramic body using die pressing, isostatic pressing or a combination of the two. The ceramic body is sintered to form a sintered ceramic body having a density of at least 93% of theoretical density. The sintered ceramic body is surrounded by a powder mixture that includes a garnet powder. The density of the sintered ceramic body is increased to 100% of theoretical density by applying an increased temperature and isostatic pressure to form the scintillator material.

Yet, according to other embodiments of the present invention, a method of making a scintillator material includes freezing and drying a ceramic slurry to form a dried ceramic composition. The ceramic slurry includes a garnet crystal formula (Gd_{3-x-z}Yₓ)Ce_{z}(Ga_{5-y}Al_{y})O₁₂, where x is about 0 to about 2, y is about 0 to about 5, and z is about 0.001 to about 1.0. The dried and compacted ceramic powder composition is sintered to form a sintered ceramic body. The sintered ceramic body is surrounded by a powder mixture that includes a garnet powder. The density of the sintered ceramic body is increased by applying an increased temperature and an isostatic pressure of argon gas (HIP, hot isostatic pressing) to form the fully dense scintillator material. The scintillator material is optically transparent when it has achieved 99% to 100% of theoretical density. Transmission is increased by performing a heat treatment after the HIP treatment in an oxidizing atmosphere.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a perspective view of a scintillator tile according to embodiments of the present invention;

FIG. 2 depicts a schematic diagram of a radiation detection system according to embodiments of the present invention;

FIG. 3 depicts a flow chart illustrating a method of forming a scintillator material according to embodiments of the present invention;

FIG. 4 is a diagram showing pulse-height spectra of scintillator materials;

FIG. 5 is a diagram of a system for measuring pulse-height of a scintillator material;

FIG. 6 is diagram showing pulse-height spectra of scintillator materials used for calibration;

FIG. 7 is a diagram showing pulse-height spectra of scintillator materials; and

FIG. 8 is a diagram showing a tile of scintillator material.

### DETAILED DESCRIPTION

For the sake of brevity, conventional techniques related to ceramic material processing may or may not be described in detail herein. Moreover, the various tasks and process steps described herein can be incorporated into a more comprehensive procedure or process having additional steps or functionality not described in detail herein.

Turning now to an overview of technologies that are more specifically relevant to aspects of the invention, radiation detection currently uses scintillator materials that include halides, e.g., NaI(Tl) (thallium doped sodium iodide NaI); CsI(Tl) (thallium doped cesium iodide); and CeF₃ (cerium fluoride). However, such materials can be fragile and quickly degrade if exposed to humidity. While garnet-based materials are more mechanically robust and unaffected by water/moisture, current processing methods and compositions prevent them from being fabricated into large panels.

Turning now to an overview of the aspects of the invention, one or more embodiments of the invention address the above-described shortcomings of the prior art by providing laser-quality, single crystal equivalent, ceramic garnet materials that are processed to form a large area or volume format. The ceramic garnet based materials are cerium doped gadolinium yttrium gallium aluminum garnet (GYGAG:Ce) scintillator materials. According to some embodiments of the present invention, the scintillator material includes Gd_{1.495}Y_{1.5}Ce_{0.005}Ga_{2.5}Al_{2.5}O₁₂. The heat treatments performed during processing are important for producing high quality materials. The pressed powders are sintered in the presence of oxygen. The sintered part is then surrounded by a mixture of similar or identical composition as the sintered part during hot isostatic pressing (HIPing). The HIPing process is performed under some conditions under which the part can become reduced, or become oxygen deficient (e.g., argon gas with graphite heaters). In addition, when the surrounding packing powder includes the element gallium (Ga), the loss of Ga in the part during HIPing is prevented. Further, the mixture of powder having a composition like that of the part being HIPed that has been used to surround the part during the HIP process is re-oxidized in air or oxygen prior to reuse.

Using GYGAG materials instead of YAG materials provides various advantages, including increased mass density, increased stopping power, higher Z_{eff} (better discrimination of radiation sources), and increased Stokes shift in emission that reduces self-absorption. Further, Gd and Ga+YAG:Ce=GYGAG:Ce yields a stable garnet material with high luminosity.

The above-described aspects of the invention address the shortcomings of the prior art by providing large-scale GYGAG:Ce scintillator materials that are more mechanically and environmentally robust than the current state of the art materials. The advanced scintillation materials can be prepared with the desired size, shape, and dopant/radiation response. The compositions and heat treatment conditions used produce high quality material with improved transparency and part uniformity.

Turning now to a more detailed description of aspects of the present invention, embodiments of the present invention are directed to a scintillator material that is an optically transparent ceramic material. The optically transparent ceramic material includes a ceramic garnet composition. The garnet composition (GYGAG) is doped with a cerium (Ce) dopant. The amount of the Ce dopant is optimized to achieve improved luminosity and energy resolution.

According to some embodiments of the present invention, the scintillator material with the formula (Gd_{3-x-z}Yₓ)Ce_{z}(Ga_{5-y}Al_{y})O₁₂, where x is about 0 to about 2, y is about 0 to about 5, and z is about 0.001 to about 1.0. According to some embodiments of the present invention, the scintillator material has the formula (Gd_{3-x-z}Yₓ)Ce_{z}(Ga_{5-y}Al_{y})O₁₂, where x is about 1.3 to about 1.5, y is about 2.5 to about 3.5, and z is about 0.001 to about 0.1. According to one or more embodiments of the present invention, the scintillator material includes a compound with the formula Gd_{1.495}Y_{1.5}Ce_{0.005}Ga_{2.5}Al_{2.5} O₁₂.

The GYGAG scintillator material has the formula (Gd_{3-x-z}Yₓ)Ce_{z}(Ga_{5-y} Al_{y})O₁₂ and includes a cerium dopant in an amount of where z is about 0.001 to about 1.0 in some embodiments of the present invention. The GYGAG scintillator material has the formula (Gd_{3-x-z}Yₓ)Ce_{z}(Ga_{5-y}Al_{y})O₁₂ and includes a cerium dopant in an amount where z is about 0.001 to about 0.150 in some embodiments of the present invention.

FIG. 1 is a perspective view of a scintillator tile 100 according to embodiments of the present invention. The scintillator tile 100 formed from the scintillator material can have any shape, and is only shown as an elongated tile as an exemplary embodiment. The shape, size, and dimension of the scintillator tile 100 depends on the scintillator detector and system size and design.

The dimensions of the scintillator tile 100 can be varied or scaled as desired. According to one or more embodiments of the present invention, the scintillator tile 100 has a length (l) of about 1 to about 100 centimeters (cm), a width (w) of about 1 to about 100 cm, and a thickness (t) of about 0.1 to about 5 cm. According to other embodiments of the present invention, the scintillator tile 100 has a length (l) of about 1 to about 10 cm, a width (w) of about 1 to about 10 cm, and a thickness (t) of about 0.1 to about 1.5 cm.

According to some embodiments of the present invention, a radiation detection system includes the scintillator material. FIG. 2 depicts a schematic diagram of a radiation detection system 200 according to embodiments of the present invention. The radiation detection system 200 includes a scintillator material 201, such as of a type described herein, and which is referred to herein interchangeably as a scintillator. The scintillator material 201 can be in the shape of a tile as described above in FIG. 1. The radiation detection system 200 also includes a photodetector 202, such as a photomultiplier tube, a silicon photomultiplier, photodiode, or other device/transducer known in the art, which can detect and register the magnitude of the light 206 emitted from the scintillator material 201. The radiation detection system 200 is configured to partially or completely determine the photon energy of said forms of radiation.

The scintillator material 201 produces light pulses upon occurrence of an event, such as a gamma ray, an x-ray, or other radiation, producing ionization in the scintillator material 201. The light 206 is detected by the photodetector 202 and transduced into electrical signals that correspond to the magnitude of the pulses. The type of radiation can then be determined by analyzing the histogram of the integrated light pulses and thereby identify the gamma ray energies absorbed by the scintillator material 201. According to some embodiments of the present invention, the radiation detection system 200 further includes a preamplifier, a multi-channel analyzer, and/or digitizer (not shown in FIG. 2).

In other embodiments of the present invention, the radiation detection system 200 includes a controller 204 for controlling the radiation detection system 200. According to one or more embodiments of the present invention, the controller 204 includes a processor that is communicatively connected to an input device, a network, a memory, and a display. In exemplary embodiments, the input device includes a keyboard, touchpad, mouse, or touch screen device, and the network includes a local area network or the Internet. The display can include a screen, touch screen device or digital display. In some embodiments of the present invention, the controller 204 includes a personal computer, smart phone or tablet device communicatively connected to the radiation detection system 200.

The processing device of the controller 204 processes pulse traces output by the photodetector 202, which correspond to light pulses from the scintillator material 201. The result can be displayed on the display device in any form, such as in a histogram of the number of counts received against the total light from the scintillator or derivative thereof.

The radiation detection systems 200 can be implemented in a variety of technologies. Non-limiting examples of applications for the radiation detection system 200 include security systems, man-portable systems, medical imaging systems, and large area remote detection systems.

FIG. 3 depicts a flow chart illustrating a method 300 for forming a scintillator material according to embodiments of the present invention. The method 300 includes, as shown in box 302, forming and drying a slurry of ceramic powder. A ceramic composition including a slurry with ceramic powders is formed.

In some approaches, the ceramic powder of the ceramic slurry has a mean particle diameter in a range from about 5 nm to about 5000 nm. In more approaches, the particles are subject to at least one processing step, such as milling, to achieve the desired particle size.

According to some embodiments of the present invention, the ceramic powder has a garnet crystal formula and includes gadolinium, yttrium, gallium, aluminum, oxygen, and a cerium dopant. According to some embodiments of the present invention, the powder has the chemical composition (Gd_{3-x-z}Yₓ)Ce_{z}(Ga_{5-y}Al_{y})O₁₂, where x is about 0 to about 2, y is about 0 to about 5, and z is about 0.001 to about 1.0. According to other embodiments of the present invention, the scintillator material has the chemical composition (Gd_{3-x-z}Yₓ)Ce_{z}(Ga_{5-y}Al_{y})O₁₂, where x is about 1.3 to about 1.5, y is about 2.5 to about 3.5, and z is about 0.001 to about 0.1. According to one or more embodiments of the present invention, the scintillator material includes a compound with the chemical composition Gd_{1.495}Y_{1.5}Ce_{0.005}Ga_{2.5}Al_{2.5}O₁₂.

The powder has the formula (Gd_{3-x-z}Yₓ)Ce_{z}(Ga_{5-y}Al_{y})O₁₂ and includes a cerium dopant in an amount of where z is about 0.001 to about 1.0 in some embodiments of the present invention. The powder has the formula (Gd_{3-x-z}Yₓ)Ce_{z}(Ga_{5-y}Al_{y})O₁₂ and includes a cerium dopant in an amount where z is about 0.001 to about 0.150 in other embodiments of the present invention.

The ceramic powder composition (GYGAG:Ce) is formed into a ceramic slurry with one or more additives. Non-limiting examples of additives include dispersants, binders, sintering aids, or a combination thereof.

Forming the slurry with a higher solids content improves packing uniformity and density, and allows more even subsequent sintering. Adding enough binder also aids in compaction. According to some embodiments of the present invention, the solids content of the slurry is about 5 to about 70 wt %.

The ceramic slurry is then dried to form a dried ceramic composition. According to embodiments of the present invention, the slurry is freeze-dried. Freeze-drying provides advantages over spray-drying, as it maintains high purity and yields. Freeze-drying includes freezing the material, and then reducing the pressure and adding heat to allow the frozen water in the material to sublimate. According to some embodiments of the present invention, the ceramic slurry is freeze-dried at a temperature of about −20 to about +35° C. According to some embodiments of the present invention, the dried slurry is screened to ensure a flowable powder. Screen mesh sizes used to screen the dried slurry are about 20 to about 400 mesh according to some embodiments of the present invention.

The method 300 also includes, as shown in box 304, pressing the dried composition into a desired body shape. According to some embodiments of the present invention, a preformed mold with the desired shape is filled with the dried slurry and pressed to increase the density. Various approaches can be used to press the dried slurry, including isopressing, die pressing, or a combination thereof. The desired green body density is at least 40% of full density according to some embodiments of the present invention.

The method 300 includes, as shown in box 306, sintering the dried ceramic green body in the presence of an oxygen-containing environment. Sintering in an oxygen-containing environment provides advantages over vacuum sintering or other alternative methods and produces a bright yellow, transparent ceramic that minimizes afterglow, and improves transparency and part uniformity. Sintering is performed in the presence of oxygen, In some embodiments of the present invention, sintering is initially performed in air (or a mixture of O₂ and N₂) to allow for binder burn-off, followed by sintering in pure O₂. According to some embodiments of the present invention, sintering is performed in the presence of oxygen and one or more gases, such as argon gas, carbon dioxide, nitrogen gas, or a combination thereof. Sintering is performed at a temperature of about 1400 to about 1800° C. according to some embodiments of the present invention.

The method 300 includes, as shown in box 308, hot isostatically pressing (HIPing) the sintered ceramic body. The HIPing process increases the density of the sintered ceramic body by applying an increased temperature and isostatic pressure. The remaining pores in the sintered body are closed so that the scintillator material becomes essentially transparent.

During HIPing, the part is surrounded by a powder mixture of the same or substantially similar composition to the part being hot isostatically pressed. Surrounding the part by this powder mixture during hot isostatic pressing helps minimize the change in composition and reduction of the part during HIPing. The surrounding powder mixture also mitigates changes in transparency and light yield of the pressed material. For example, the part including GYGAG:Ce or GYGAG is surrounded by a powder mixture of a garnet compound, such as GYGAG:Ce or GYGAG including elements in the same amounts. The powder mixture is poured onto all sides of the part, including the top and bottom.

According to one or more embodiments of the present invention, hot isostatic pressing is performed under an isostatic pressure of about 15,000 psi to about 30,000 psi. According to some embodiments of the present invention, hot isostatic pressing is performed at a temperature of about 1500 to about 1700° C.

The method 300 includes, as shown in box 310, annealing to re-oxidize and form the final scintillator material. Annealing is performed in an oxygen-containing environment. The oxygen-containing environment provides advantages over vacuum annealing or other alternative methods and produces a bright yellow, transparent ceramic that minimizes afterglow, and improves transparency and part uniformity. Annealing is performed in air, for example. Annealing is performed in the presence of oxygen, but not in the presence of pure oxygen, as an oxygen content that is too high has a deleterious effect on the transparency of the hipped material. According to some embodiments of the present invention, annealing is performed in the presence of oxygen and one or more gases, such as argon gas, carbon dioxide, nitrogen gas, helium, or a combination thereof.

Annealing is performed at a temperature of about 1000° C. to about 1400° C. according to some embodiments of the present invention. Annealing at a temperature over 1300° C. can produce optical scatter, and therefore, a temperature of less than 1300° C. is used for annealing in some embodiments (about 1000 to about 1300° C.).

### EXAMPLES

The above described compositions and methods result in scintillator materials with optimal properties, including luminosity, transparency, and radiation response. The following examples illustrate properties of the scintillator materials.

FIG. 4 is a diagram comparing pulse-height spectra (or scintillator light yield) of GYGAG:Ce scintillator materials that were annealed under different conditions, Gd_{1.495}Y_{1.5}Ce_{0.005}Ga_{2.5}Al_{2.5}O₁₂ (GYGAG:Ce 0.17%). The top diagram 400 shows pulse-height spectra of the scintillator material prepared with O₂ sintering and N₂+O₂ annealing. The bottom diagram 402 shows pulse-height spectra of the scintillator material prepared by vacuum sintering and air annealing. Arbitrary counts are shown in each diagram as a function of the channel number.

The energy resolution of each material is a function of the half-width of the largest peak, which is peak 410 for the 02 sintering and N₂+O₂ annealing material in the top diagram 400 and peak 412 for the vacuum sintering and air annealing in diagram 402. As shown, sintering in O₂ and annealing in N₂+O₂ provides optimal energy resolution for the scintillator material.

FIG. 5 is a diagram of a system 500 used for measuring pulse-height and luminosity of the scintillator materials. Cesium-137 (Cs-137) is used as the standard source to test scintillator materials because it emits a single energy gamma ray (662 keV) as illustrated in FIG. 6, and the energy is in the middle of most radiation sources. A 7 micro-Ci Cs-137 (Eckert & Ziegler) disc source was used. A dark box is used to eliminate unwanted stray background light, which is important to avoid saturation of the light detector and also to minimize after-glow under room lighting conditions.

To improve light collection to the photon detector, as well as consistent measurements for samples under the same conditions, the back and sides (not the face) of each of the polished samples was tightly wrapped with highly reflective Teflon tape. The contact surface to the light detector is sealed by optical grease (e.g., silicone oil). A super bi-alkali photomultiplier tube (SBA-PMT, <1.6 ns rise time, Hamamatsu R6200 for large samples or R7600 for small ones) was used to maximize the light detection with a quantum efficiency (QE) of 20% at 550 nm. The pulsed signal from the PMT is amplified by a pre-amplifier (Canberra Model 2005). The preamplifier (“Pre-Amp”) collects the charge output from the PMT detectors for presentation to a pulse shaping main amplifier (“Shaping Amp”). For the typical application, with input from the decoupled anode signal from a photomultiplier tube base, the preamplifier generates a positive polarity energy pulse output. Charge conversion gains are nominally 4.5 or 22.7 mV per picocoulomb (pC). The pre-amplified signal is shaped by the spectroscopy amplifier (Canberra 2202 or 2205) with variable gain setting (10-3k) at given PMT high voltage and shaping time (0.5-12 microsecond). The shaping time is set normally to 4 microseconds, which is common for most of the measurements. However, if there is a long decay component, 12 microsecond shaping time is used instead (e.g. occasionally for GYGAG).

Simultaneous unipolar and bipolar outputs from the spectroscopy amplifier can be used at both panel connectors. The unipolar signal was used for spectral analysis. The bipolar output was used for counting, timing, or gating for other modes, such as coincidence/anti-coincidence measurements. The multiple pulses with different pulse heights were being recorded using the multi-channel analyzer (“MCA”) (Amptek 8000A), and the spectrum was collected using ADMCA software from Amptek.

FIG. 6 is a diagram showing pulse-height spectra of scintillator materials used for calibration. Arbitrary units are shown as a function of channel number. Curve 602 shows the Cs-137 spectrum used for calibration. Curve 604 shows the spectrum for reference material bismuth germinate crystal (BGO). Curve 606 shows the spectrum for reference material YAG (YAG:Ce (0.3%)).

The output signal from the pre-amplifier (“Pre-Amp”) goes directly to the sampling oscilloscope (“Sampling Osc”) (2 GHz, 40 GS/s sampling rate, LeCroy Waverunner 6Zi) for monitoring. The sampling oscilloscope provided direct measurement of decay time of the scintillation light with a Cs-137 gamma source as a pulse excitation source. The decay dynamics were directly observed under actual radioactive source illumination including neutron radiation. With the sampling oscilloscope, the pulse shape of the scintillation light pulses were measured directly in the internal triggering mode. Pulse shapes were analyzed using a decay time fitting program (multiple exponential decay curves). The tool had a pulse distribution display that was similar to the PHA (pulse height analysis) so that radiation detection performance was observed prior to any precise measurements.

For the measurement of luminosity (i.e., the number of photons per MeV, Ph/MeV), the BGO crystal having known luminosity (7000 Ph/MeV, Hilger Crystal, calibrated by RMD Inc.) was used as a reference. BGO has a high mass density and does not contain any extrinsic activators for scintillation. Therefore, variability of luminosity associated with different doping level and thickness differences could be avoided.

FIG. 7 is a diagram showing pulse-height spectra of scintillator materials. The intensity in arbitrary units is shown as a function of photomultiplier channel number. Curve 702 shows GYGAG:Ce 0.3%. Curve 704 shows GYGAG:Ce 0.17%. Curve 706 shows YAG:Ce 0.3%. From this data, the luminosity was determined for each material as follows. For GYGAG:Ce 0.3%, the luminosity was 24,400 Ph/MeV. For GYGAG:Ce 0.17%, the luminosity was 26,300 Ph/MeV. For YAG:Ce 0.3%, the reference, the luminosity was 21,000 Ph/MeV.

FIG. 8 illustrates a tile 800 of scintillator material. The tile 800, as shown, demonstrates high transparency.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method of making a scintillator material, the method comprising:
forming a dried ceramic composition into a ceramic body comprising a chemical composition (Gd_{3-x-z}Yₓ)Ce_{z}(Ga_{5-y}Al_{y}) O₁₂, where x is about 0 to about 2, y is about 0 to about 5, and z is about 0.001 to about 1.0;
sintering the ceramic body to form a sintered ceramic body; and
surrounding the sintered ceramic body by a powder mixture comprising a garnet powder; and
increasing a density of the sintered ceramic body by applying an increased temperature and isostatic pressure to form the scintillator material.

2. The method of claim 1, wherein the chemical composition is Gd_{1.495}Y_{1.5}Ce_{0.005} Ga_{2.5}Al_{2.5}O₁₂.

3. The method of claim 1, wherein sintering the ceramic body is performed in a presence of oxygen.

4. The method of claim 1, wherein the temperature used to increase the density of the sintered ceramic body is about 1500 to about 1700° C.

5. The method of claim 1 further comprising annealing, subsequent to increasing the density of the sintered ceramic body, at a temperature of about 1000 to about 1300° C.

6. A scintillator material formed by the method of claim 1.

7. A scintillator detection system comprising the scintillator material formed by the method of claim 1.

8. A method of making a scintillator material, the method comprising;
forming a slurry comprising a garnet crystal formula (Gd_{3-x-z}Yₓ)Ce_{z}(Ga_{5-y}Al_{y}) O₁₂, where x is about x is about 0 to about 2, y is about 0 to about 5, and z is about 0.001 to about 1.0;
drying the slurry to form a dried ceramic powder composition;
forming the dried ceramic powder composition into a ceramic body;
sintering the ceramic body to form a sintered ceramic body;
surrounding the sintered ceramic body by a powder mixture comprising a garnet powder; and
increasing a density of the sintered ceramic body by applying an increased temperature and isostatic pressure to form the scintillator material.

9. The method of claim 8, wherein the garnet crystal formula is Gd_{1.495}Y_{1.5}Ce_{0.005} Ga_{2.5}Al_{2.5}O₁₂.

10. The method of claim 8, wherein sintering the ceramic body is performed in a presence of oxygen.

11. The method of claim 8, wherein the temperature used to increase the density of the sintered ceramic body is about 1500 to about 1700° C.

12. The method of claim 8 further comprising annealing, subsequent to increasing the density of the sintered ceramic body, in a presence of oxygen at a temperature of about 100 to about 1300° C.

13. A scintillator material formed by the method of claim 8.

14. A scintillator detection system comprising the scintillator material formed by the method of claim 8.

15. A method of making a scintillator material, comprising:
freezing and drying a ceramic slurry to form a dried ceramic composition, the ceramic slurry comprising a garnet crystal formula (Gd_{3-x-z}Yₓ)Ce_{z}(Ga_{5-y}Al_{y}) O₁₂, where x is about 0 to about 2, y is about 0 to about 5, and z is about 0.001 to about 1.0;
sintering the dried ceramic composition to form a sintered ceramic body;
surrounding the sintered ceramic body by a powder mixture comprising a garnet powder; and
increasing a density of the sintered ceramic body by applying an increased temperature and isostatic pressure to form the scintillator material.

16. The method of claim 15, wherein the garnet crystal formula is Gd_{1.495}Y_{1.5}Ce_{0.005} Ga_{2.5}Al_{2.5}O₁₂.

17. The method of claim 15, wherein sintering the ceramic body is performed in a presence of oxygen.

18. The method of claim 15 further comprising annealing, subsequent to increasing the density of the sintered ceramic body, in a presence of oxygen at a temperature of about 1000 to about 1300° C.

19. A scintillator material formed by the method of claim 15.

20. A scintillator detection system comprising the scintillator material formed by the method of claim 15.
